(19) United States
(12) Patent Application Publication
(10) Pub. No.: US 2008/0208639 A1
(43) Pub. Date: Aug. 28, 2008

(54) SYSTEM AND METHOD FOR PROCESSING WARRANTY CLAIMS

(76) Inventor: Mark Pattison, Seattle, WA (US)

Correspondence Address: PERKINS COIE LLP;PATENT-SEA, P.O. BOX 1247, SEATTLE, WA, 98111-1247, US

(21) Appl. No.: 12/036,130

(22) Filed: Feb. 22, 2008

Related U.S. Application Data
(60) Provisional application No. 60/891,446, filed on Feb. 23, 2007.

(51) Int. Cl. G06Q 30/00

(52) U.S. Cl. 705/4

(57) ABSTRACT

A software and/or hardware facility for enabling warranty claims processing between warrantors and warrantees. The facility allows a warrantee to identify if a particular product or service is covered by a warranty, and to make a warranty claim for such covered product or service. Upon submission of a warranty claim, the facility may perform steps to verify and authorize the warranty claim. The facility may also provide the warrantee with instructions on how to tender the product or service to the warrantor. The facility notifies the warrantor of the submission of the warranty claim. The facility enables the creation of detailed reports on warranty claims for warrantees and warrantors.

### CROSS-REFERENCE TO RELATED APPLICATION

This application claims priority to U.S. Provisional Patent Application No. 60/891,446 (Attorney Docket No. 63764-8001.US00) entitled “SYSTEM AND METHOD FOR PROCESSING WARRANTY CLAIMS,” and filed on Feb. 23, 2007, which is hereby incorporated by reference.

### TECHNICAL FIELD

The described technology relates to the field of processing warranty claims.

### BACKGROUND

It is common in modern commerce for products to be sold, or services to be provided, with a warranty. A warranty typically provides that a product or service will meet certain specifications. A warrantor is one who makes a warranty covering a product or service, and may be a manufacturer, distributor or service provider. A warrantee is one to whom a warranty is made, and may be a consumer, retailer or other end consumer of a product or end user of a service. When a product or service does not meet proscribed specifications, a warrantee typically has the option of making a claim under the warranty, called making a warranty claim.

It can be very difficult for a warrantee to make a warranty claim and have it properly fulfilled by the warrantor. The warrantee may not know if a particular product or service is covered by a warranty. To determine this, the warrantee may have to search for documentation or contact the warrantor. Even if the particular product or service is covered by a warranty, the warrantee may not know how to make a warranty claim or it may not be cost-effective or time-efficient for the warrantee to make a warranty claim. Even if the warrantee successfully makes a warranty claim, the warrantee may not be able to track the warranty claim and identify if it has been properly fulfilled.

From the warrantor's perspective, it can be very difficult to properly fulfill warranty claims. The warrantor may not know if a submitted warranty claim should be approved or rejected because it may not know if the particular product or service is covered by a warranty. Even if the warrantor approves a warranty claim, the warrantor may store related data in disparate systems that do not facilitate proper fulfillment of the warranty claim. Such systems may not provide a single unified view of all submitted warranty claims that enables detailed reporting on warranty claims.

It would therefore be beneficial to automate the warranty claims process, so that a warrantee can quickly and cost-effectively make warranty claims and have them properly fulfilled. An automated warranty claims process would further benefit warrantors by facilitating approvals or rejections of warranty claims and by enabling detailed reporting on warranty claims.

### BRIEF DESCRIPTION OF THE DRAWINGS

FIG. 1 is a block diagram that illustrates components of a facility for processing warranty claims.

FIG. 2 is a flow diagram of a process for receiving a warranty claim submitted by a warrantee.

FIG. 3 is a block diagram of a product or service search interface.

FIG. 4 is a block diagram of an interface depicting products that match a warrantee search term that pertains to products.

FIG. 5 is an interface depicting a matching product and its corresponding warranty.

FIG. 6 is a block diagram of a warranty claim submission form.

FIG. 7 is a block diagram of a data structure for storing submitted warranty claim data.

FIG. 8 is a block diagram of an interface depicting a summary of a submitted warranty claim.

FIG. 9 is a block diagram of an interface depicting submitted warranty claims.

FIG. 10 is a block diagram of an interface that depicts warranty claims versus number of products warranted.

### DETAILED DESCRIPTION

A software and/or hardware facility for enabling warranty claims processing between warrantors and warrantees is disclosed. The facility allows a warrantee to identify if a particular product or service is covered by a warranty. The facility further allows a warrantee to make a warranty claim for covered products or services. Upon submission of the warranty claim, the facility may perform steps to verify and authorize the warranty claim. The facility may provide the warrantee with instructions on how to tender the product or services to the warrantor.

Once a warrantee has submitted the warranty claim, the facility notifies the warrantor of the submission. In some embodiments the notification may be done by emailing the warrantor the details of the submitted warranty claim. In other embodiments the facility may interact directly with the warrantor's back-end computer systems, such as inventory, quality control, and accounting systems to communicate the warranty claim details. The facility may tender warranty claims immediately after receipt from the warrantee, or may tender groups of warranty claims to the warrantor on a periodic basis.

In some embodiments, the facility enables the creation of detailed reports on warranty claims. The facility allows a warrantee to quickly view submitted warranty claims. Warranty claims may be grouped by product or service, warranty claim status, or warrantor. The facility may thus provide the warrantee with valuable information, enabling the warrantee to recoup costs and intelligently place future orders of products or services. The facility further allows a warrantor to quickly view submitted warranty claims. Warranty claims may be grouped by product or service, warranty claim status, or warrantee. The facility may thus provide the warrantor with valuable information, enabling the warrantor to identify quality control issues and generally improve warrantor-warrantee relations.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

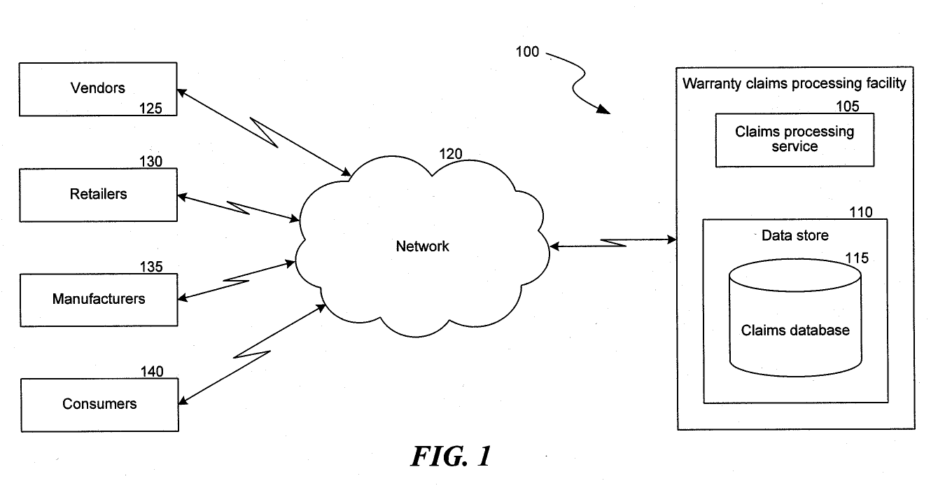

FIG. 1 is a block diagram illustrating components of a warranty claims processing facility 100. The facility is comprised of a number of components to process warranty claims, including a claims processing service 105 that is coupled to a data store 110 which contains a claims database 115. The facility receives warranty claims submitted by one or more parties, including vendors 125, retailers 130, manufacturers 135, consumers 140, and others. A party seeking warranty coverage for a product or service interacts with the facility 100 over a network, such as the Internet 120, to submit a warranty claim. The claims processing service 105 receives submitted warranty claims, processes the claims by providing instructions to the warrantee and reporting the claim to the warrantor, and produces warranty claim reports for the warrantee and/or to the warrantor. The facility stores data related to potential and actual warranty claims in the claims database 115, including product information, warranty information, and information related to warrantors and warrantees. It will be appreciated that, depending on the factual circumstances associated with the use of a product or service, vendors 125, retailers 130, manufacturers 135, and consumers 140 may be a warrantor and/or a warrantee. For example, a manufacturer may provide products or services covered by a warranty to a retailer for use by the retailer in the retailer's business. In this example, the manufacturer is a warrantor and the retailer is a warrantee. As a further example, a retailer may provide to consumers products or services covered by a warranty (sometimes called an extended warranty) in addition to that of the original warranty. In this example, the retailer is a warrantor and the consumer is a warrantee.

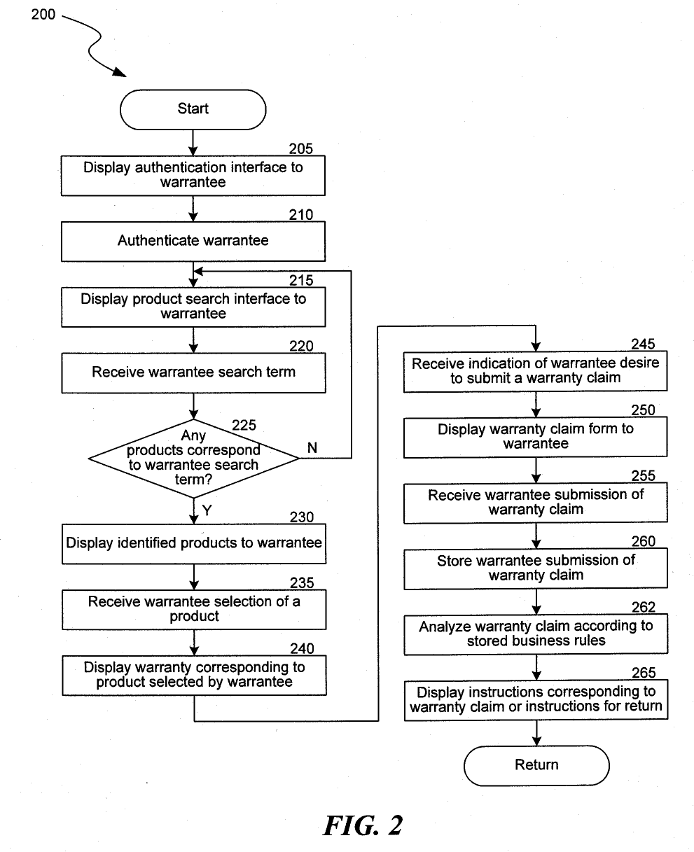

FIG. 2 is a flow diagram of a process 200 implemented by the facility to enable a warranty claim to be submitted by a warrantee. At a block 205, the facility displays an interface to a warrantee in order to identify and authenticate the warrantee. Those skilled in the art will appreciate that a warrantee can be authenticated in a variety of ways, such as a username and password combination, a digital certificate, or a biometric identifier. At a block 210, the facility receives information from the warrantee that is sufficient to authenticate the warrantee.

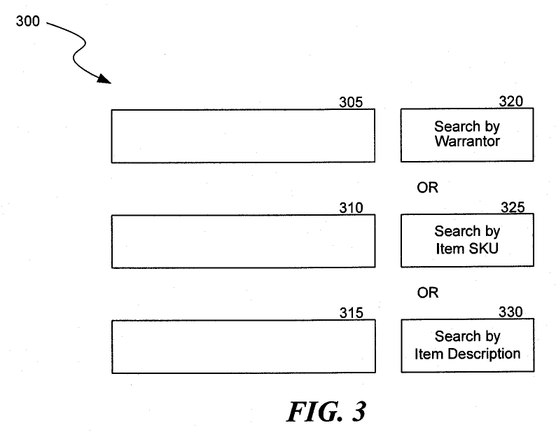

After authenticating the warrantee, at a block 215 the facility displays a search interface that enables the warrantee to search for a product or service on which a warranty claim is to be made. FIG. 3 is a block diagram of a representative product or service search interface 300, such as may be generated by the facility. The search interface allows a warrantee to search for a desired product or service using different search methodologies. For example, a warrantee may search for a product or service by warrantor name. The warrantee enters the warrantor name as a search term in field 305 and clicks on button 320 to initiate the search. Or, a warrantee may search for a product or service by item SKU by entering the SKU in field 310 and clicking on button 325. Or, a warrantee may search for a product or service by description by entering one or more terms from the description in field 315 and clicking on button 330. Those skilled in the art will appreciate that other search or browse interfaces may be implemented by the facility, such as a single field that accepts any search string and compares the search string against a database of warrantors, SKUs, descriptions, etc., or a browse hierarchy that allows a warrantee to browse to a desired product or service. Moreover, the search or browse may be constrained by known or predicted information about the warrantee. For example, the facility may have knowledge about prior purchases made by the warrantee, and may limit the products or services that the warrantee can search or browse to those products or services that the warrantee currently owns. As another example, the facility may have knowledge of the particular industry of the warrantee and may place products or services likely to be used in that industry higher in the search results list or browse hierarchy than products or services that are not likely to be used. When searching on “cutters,” a warrantee in the printing industry might therefore be displayed paper cutters, whereas a warrantee in the baking industry may be displayed cookie cutters.

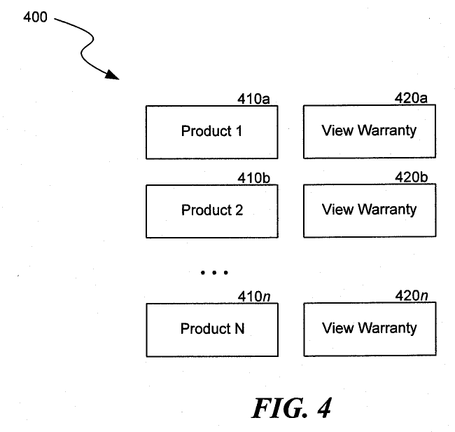

Returning to FIG. 2, the facility receives a search term from the warrantee at a block 220. At a block 225, the facility determines if any products or services correspond to the warrantee search term. If there are no corresponding products or services the facility returns to block 215 where the warrantee may enter another search term. If there are corresponding products or services, the facility displays the search results to the warrantee at a block 230. FIG. 4 is a block diagram of a representative display 400 of products and/or services that match a search term entered by a warrantee. One or more products or services 410a, 410b . . . 410n may match a warrantee search term, and the facility displays the matching products or services in a list with the most relevant products or services closer to the beginning of the list. For each displayed product or service 410a, 410b . . . 410n that has a warranty, the facility displays a corresponding button 420a, 420b, . . . 420n. The warrantee may view the warranty for a particular product or service by clicking on or otherwise selecting the corresponding button. Those skilled in the art will appreciate that by maintaining an electronic database of warranty terms, the warranty terms may be periodically updated or revised by the warrantor. Historic versions of the warranty terms may be maintained so that the appropriate warranty terms may be matched to products or services that were purchased during the period when the warranty terms were applicable.

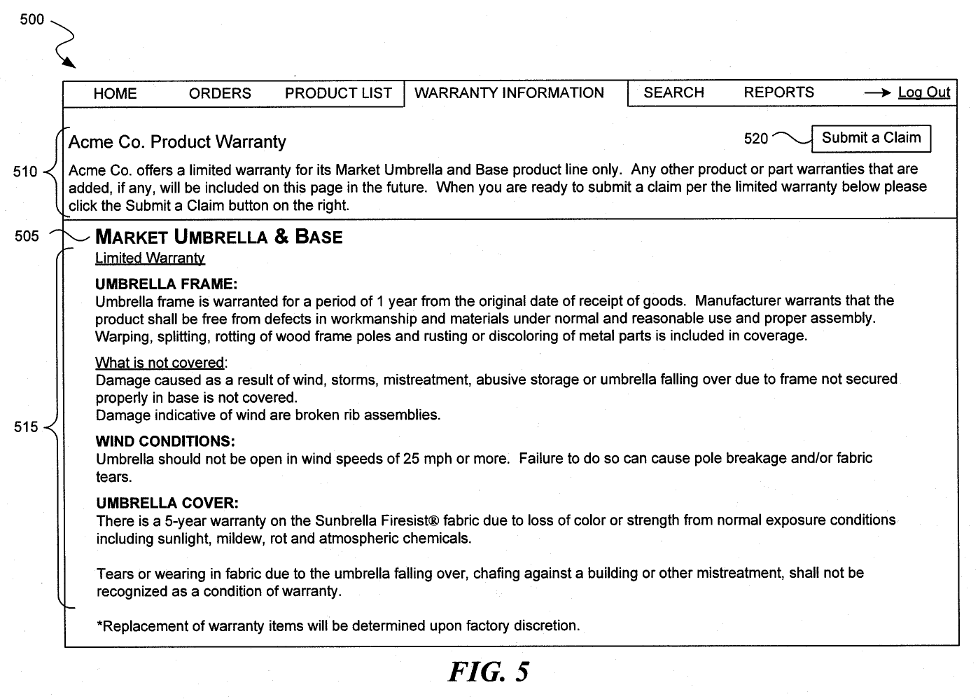

Returning to FIG. 2, at a block 235 the facility receives a warrantee's selection of a product or service from the list of products or services that are displayed to the warrantee. At a block 240 the facility displays the warranty corresponding to the selected product or service. FIG. 5 is a representative display 500 of a selected product 505 and its corresponding warranty 515. The product depicted in FIG. 5 is an umbrella and base, and the limited warranty 515 describes the conditions under which the umbrella and base will be repaired or replaced by the warrantor. A portion of the display is used by the facility to identify the warrantor 510 of the product or service as well as to provide a few details about the warrantor. By providing a clear identification of the product or service and the warranty corresponding to the product or service, the warrantee is quickly able to assess whether they have a claim that can be made under the terms of the warranty. If the warrantee believes that they have a warranty claim for the product or service, they may select a button 520 which results in the display of a form or other data entry screen that may be used by the warrantee to submit the warranty claim. At a block 245 the facility receives an indication of a warrantee desire to submit a warranty claim.

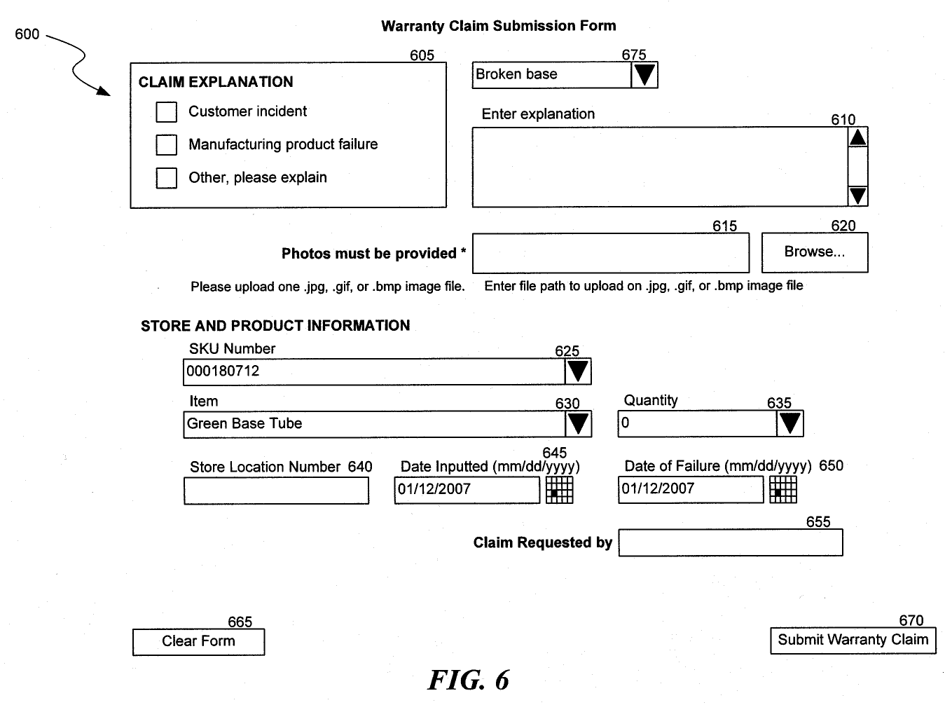

If the warrantee indicates that they would like to submit a warranty claim, at a block 250 the facility displays a warranty claim form to the warrantee. FIG. 6 is a block diagram of a representative warranty claim submission form 600. The warranty claim form is divided into a number of regions that enable the warrantee to submit pertinent information that facilitates the processing of the claim by the warrantor. For example, the facility provides a claim selection region 605 and a claim explanation region 610 on the form to allow the warrantee to provide a general description of the claim. The facility may also provide a drop-down list 675 that lists the most common claim explanations. The claim explanations may be generated by the warrantor based on the anticipated or actual failure modes of a product or service, or dynamically generated by the facility based on previously submitted warranty claim explanations. The list may be ordered to present claims having the highest probability of occurrence first, followed by claims that are less likely to occur. When submitting a warrantee claim, the warrantee may check a box in the claim selection region, select a claim explanation from the drop-down list, and provide a lengthier explanation in the claim explanation region if so required. The facility allows a warrantee to attach a digital photo to the warranty claim by specifying the file path in field 615, or by clicking on button 620 and browsing to the digital photo file. The facility also provides a series of text entry fields and dropdown lists to allow the warrantee to provide additional details of the claim. For example, the facility provides a first drop-down list 625 that lists product or service SKUs and a second drop-down list that lists item descriptions. In some embodiments, drop-down lists 625 and 630 are populated with SKUs and item descriptions corresponding to other products or services that are covered by the same warranty, or components of a particular product or service for which warranty service is sought. For example, the warrantee may be able to specify a particular component of a product that has failed and for which they are seeking warranty coverage. The facility also provides a drop-down list 635 to allow the warrantee to select the number of items for which the warrantee is submitting a warranty claim (e.g., in the event that the warrantee is a retailer and is submitting claims for a group of returned products that have failed). The facility further provides a store location number field 640, to allow the warrantee to specify a store location number, a date input field 645 to allow the warrantee to specify the date that the warranty claim submission form was completed, a date of failure field 650 to allow the warrantee to specify the date that the product or service failed, and a claim request field 655 to allow the warrantee to enter a name or other identifier that becomes associated with the claim. If errors are made during completion of the form, a clear form button 665 is provided to allow the warrantee to clear the entire form and start the process over. If the warrantee is satisfied that the form has been accurately completed, warrantee may select a submit warranty claim button 670 to instruct the facility to begin processing the claim. As is depicted in FIG. 6, one or more of the fields may be pre-populated with data by the facility to reduce the amount of time necessary to complete the form. The warrantee is allowed to accept the pre-populated data, or may edit or re-enter the data as desired.

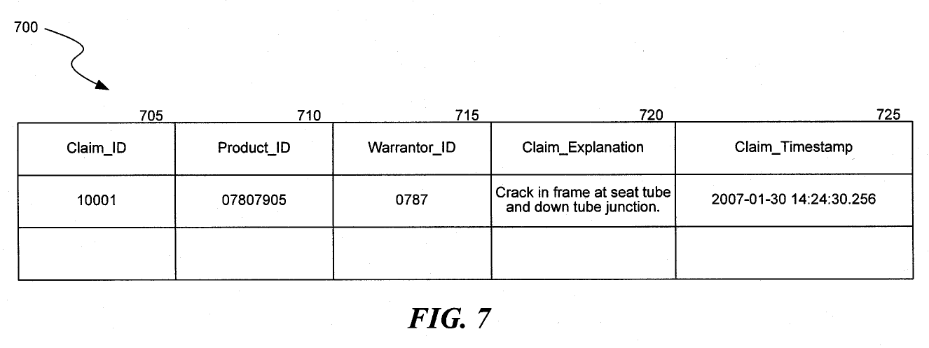

Returning to FIG. 2, at a block 255 the facility receives a submission of a warranty claim from a warrantee. Such a submission results from the completion of the warranty claims submission form 600 or similar data input. The facility stores the submission at a block 260. FIG. 7 is a block diagram of a table 700 for storing submitted warranty claim data. Each row in the table represents a different warranty claim. Each column in the table contains a different piece of data associated with the warranty claim. For example, the facility assigns a unique identification number to each submitted warranty claim and stores the unique identifier in a claim ID field 705. The facility also stores the product identification number in a product ID field 710, the warrantor identification number in a warrantor ID field 715, the claim explanation in a claim explanation field 720 and the date and time of the warranty claim submission in the timestamp field 725. Other fields (not shown) may store other data associated with the warranty claim. While FIG. 2 depicts a table whose contents and organization are designed to make it more comprehensible to the human reader, those skilled in the art will appreciate that the actual data structure used by the facility to store this information may differ from the table shown. For example, the table may be organized in a different manner, may contain more or less information than shown, may be compressed and/or encrypted, and may otherwise be optimized in a variety of ways.

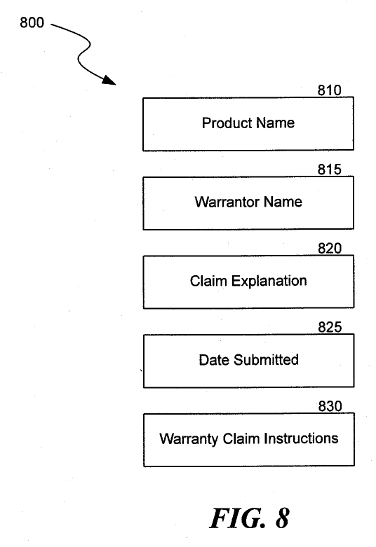

Returning to FIG. 2, after the warranty claim has been submitted by the warrantee, at a block 262 the facility may analyze the warranty claim according to stored business rules that are pre-defined by the warrantor to either approve or reject the warranty claim. At a block 265 the facility may summarize the warranty claim to the warrantee as well as display instructions corresponding to the warranty claim, or indicate to the warrantee that the warranty claim has been rejected and provide return instructions to the warrantee instead. FIG. 8 is a block diagram of a representative interface 800 that is displayed to the warrantee after submission of a warranty claim. The facility displays a summary of the submitted warranty claim, including the product or service name 810, the warrantor name 815, the claim explanation 820, and the date submitted 825. In some embodiments, the facility may also display further warranty claim instructions 830 to the warrantee. The warranty claim instructions 830 may include a Return Merchandise Authorization (RMA) number and a pre-printed shipping label that the warrantee may use to return the product or service to the warrantor. The pre-printed shipping label may be unique to the product or service being returned, and may allow the warrantor to direct returns based on geography, resources, or other factors. For example, warrantees on the East Coast of the United States may be directed to return products or services to one address, whereas warrantees on the West Coast of the United States may be directed to return products or services to a second address. As another example, products or services may be returned to one warehouse of a warrantor until the resources at that warehouse are filled, at which time the products or services may be returned to a different warehouse of the warrantor. Moreover, if the warrantee is a retailer, the instructions given to the warrantee may direct the warrantee to hold the product or service for a period of time. As will appreciated from the following discussion, because the facility aggregates warranty claims over a large population it is possible for the facility to predict the number and timing of warranty claims. For certain warrantees that sell a large number of products or services, it may be more efficient for the facility to instruct the warrantee to hold products or services having warranty claims until there are sufficient numbers of products or services to ship the products or services together and therefore save in overall shipping costs. Other uses of the warranty claim instructions will be apparent to those skilled in the art.

After a warranty claim has been submitted to the facility, the facility tenders the warranty claim to the warrantor. The tender may occur as the warranty claims are submitted to the facility, or may occur on a periodic basis. In some embodiments the facility may email the warrantor data associated with a warranty claim or a notification indicating that a new warranty claim has been submitted and providing a link to the facility's reporting interface. In some embodiments, the facility may interact directly with the warrantor's back-end computer systems, such as inventory, quality control, and accounting systems to communicate the warranty claim details. For example, the facility may interact with the warrantor's inventory system so as to permit the inventory system to provide products or services to replace those for which a warranty claim has been submitted. As a further example, the facility may interact with the warrantor's accounting system so as to enable the accounting system to adjust the warrantor's allowance for warranty expenses. As a further example, the facility may receive notifications from the warrantor's quality control system regarding the status of submitted warranty claims, so as to permit the facility to notify the warrantee of the status of its submitted warranty claims. Those skilled in the art will appreciate other ways that the facility may interact with the warrantor's back-end computer systems.

After notifying the warrantor of a submitted warranty claim, the facility may approve or reject the submitted warranty claim or enable the warrantor to approve or reject the submitted warranty claim. In some embodiments, the facility stores business rules pre-defined by the warrantor that the facility applies to approve or reject a warranty claim. For example, the facility may apply a business rule to reject all warranty claims submitted after the expiration of a warranty term. In some embodiments, the facility may provide the warrantor with an interface to approve or reject a submitted warranty claim. In some embodiments, if the warranty claim is rejected, the facility may process the warranty claim as a return claim. When processed as a return claim, the facility may present return or repair information to the warrantee such as a shipping address for an authorized repair shop.

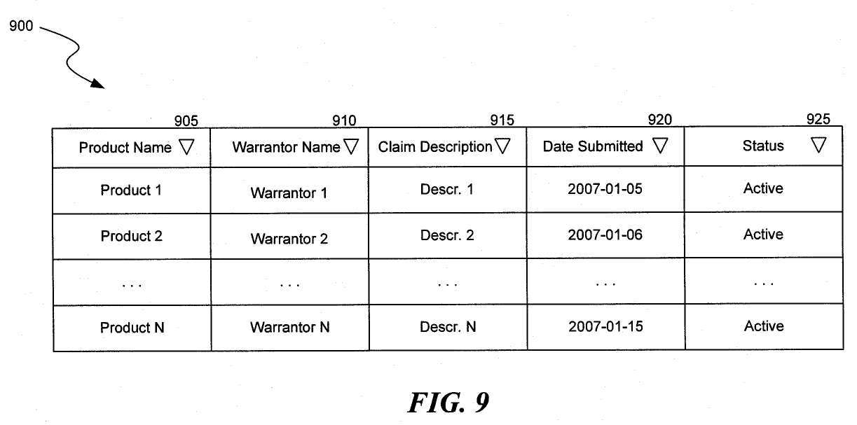

FIG. 9 is a block diagram of a reporting interface 900 depicting warranty claims submitted by a warrantee. Each row in the reporting interface represents a different warranty claim. Each column in the reporting interface contains a different piece of data associated with a warranty claim. A warrantee may sort or group its submitted warranty claims, such as for claims 1 through N as shown, by data in the different columns. The facility displays the name of the product in product name column 905, the name of the warrantor in warrantor name column 910, a description of the claim in claim description column 915, the date the warranty claim was submitted in date submitted column 920, and the status of the warranty claim in claim status column 925. Clicking on or otherwise selecting one of the displayed warranty claims may take the warrantee to a page (not shown) that provides further details about the warranty claim. A warrantee may sort or group its submitted warranty claims by other data fields (not shown) associated with the warranty claim. One skilled in the art will understand the reporting interface may enable the warrantee to select, browse, sort, group or filter warranty claims by other techniques that are well known in the art. By presenting all of the warranty claims submitted by the warrantee in one location, the facility enables the warrantee to easily manage a large number of claims and ensure that all claims are appropriately processed and the terms of the warranty fulfilled. In particular, the status field allows the warrantee to see at a glance the current state of all submitted claims. When data is available, the status field may include the expected date on when each claim will be fulfilled.

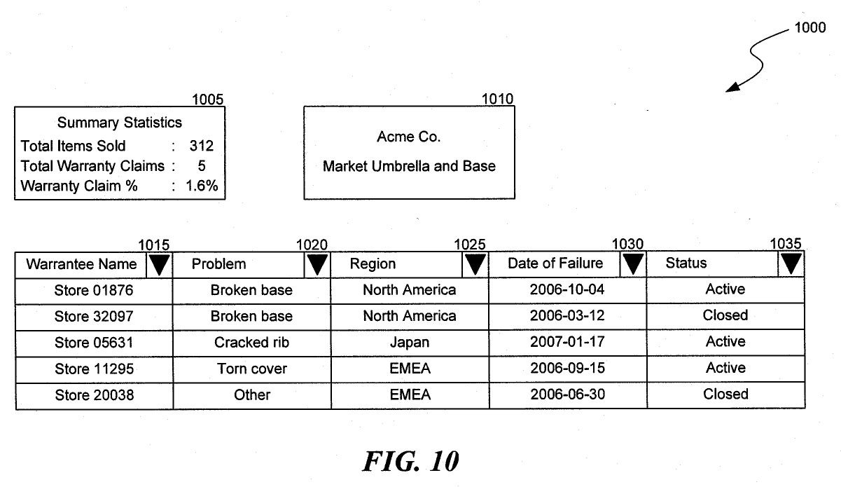

FIG. 10 is a block diagram of a reporting interface 1000 that depicts warranty claims versus number of warranted products or services. A product or service identification region 1010 is provided by the facility to display the warrantor name and the product or service that is currently reflected by the interface. The facility includes a summary statistics region 1005, which may include the total number of products or services warranted by a warrantor, the total number of warranty claims made against the warranted product or service, and a warranty claim percentage that reflects a ratio of warranty claims made versus number of warranted product or service. Individual warranty claims associated with the product or service may be displayed in a table in the reporting interface 1000. Each row in the table represents a warranty claim submitted to the warrantor. The facility displays the name of the warrantee that submitted the warranty claim in name column 1015, a description of the problem for which warranty coverage is being sought in problem column 1020, the geographic region of the warrantee in region column 1025, the date of failure of the product or service in date of failure column 1030, and the status of the warranty claim in status column 1035. A greater or lesser number of columns may be displayed in the table, and clicking on or otherwise selecting one of the displayed warranty claims may take the warrantor to a page (not shown) that provides further details about the warranty claim. A warrantor may sort or group warranty claims by the data in each column. For example, clicking on the problem column heading causes the table to be sorted by type of product or service failure. The warrantor may use such information in a variety of ways, such as to improve their product or service by seeking to eliminate the primary failure mode. By presenting all of the warranty claims submitted against products or services warranted by a warrantor in one location, the facility also enables the warrantor to easily manage a large number of claims and ensure that all claims are appropriately processed and the terms of the warranty fulfilled. In particular, the status field allows the warrantor to see at a glance the current state of all submitted warranty claims and to determine which claims still need to be addressed.

While various embodiments are described in terms of the environment described above, those skilled in the art will appreciate that various changes to the facility may be made without departing from the scope of the invention. For example, the claims database 115 is indicated as being contained in a general data store area 110. Those skilled in the art will appreciate that the actual implementation of the data storage area may take a variety of forms, and the term “database” is used herein in the generic sense to refer to any data stored in a structured fashion that allows data to be accessed, such as by using tables, linked lists, arrays, etc.

Those skilled in the art will also appreciate that the facility may be implemented in a variety of environments including a single, monolithic computer system, a distributed system, as well as various other combinations of computer systems or similar devices connected in various ways. Moreover, the facility may utilize third-party services and data to implement all or portions of the warranty processing functionality. Those skilled in the art will further appreciate that the steps shown in FIG. 2 may be altered in a variety of ways. For example, the order of the steps may be rearranged, substeps may be performed in parallel, steps may be omitted, or other steps may be included.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A system for processing a warranty claim made by a warrantee for an item covered by a warranty provided by a warrantor, the system comprising:
a storage component that stores information about a plurality of items and information on warranties from at least one warrantor corresponding to each of the plurality of items;
a first display component that selectively displays stored warranty information associated with the plurality of items to a warrantee, the first display component allowing the warrantee to select one of the plurality of items for submission of a warranty claim to the corresponding warrantor;
a claim input component that receives a warranty claim for the selected item from the warrantee, wherein the received warranty claim includes an item identification and a warranty claim explanation; and
a second display component that displays to the warrantee instructions on how to tender the item to the warrantor in accordance with the received warranty claim.

2. The system of claim 1, wherein the item is a product.

3. The system of claim 1, wherein the item is a service.

4. The system of claim 1, wherein the received warranty claim is stored in the storage component.

5. The system of claim 1, wherein the first display component enables the warrantee to search by keyword to locate and select one of the plurality of items.

6. The system of claim 1, wherein the first display component enables the warrantee to navigate through a browse structure to locate and select one of the plurality of items.

7. The system of claim 1, further comprising a notification component that notifies the corresponding warrantor that the warranty claim has been received.

8. The system of claim 7, further comprising a claim management component that enables the corresponding warrantor to approve or reject the received warranty claim.

9. The system of claim 1, further comprising an authorization component that approves or rejects the received warranty claim based upon stored rules provided by the corresponding warrantor.

10. The system of claim 1, further comprising a reporting component that displays to the warrantee reports on warranty claims received from the warrantee.

11. The system of claim 1, further comprising a reporting component that displays to the warrantor reports on warranty claims associated with the warrantor.

12. The system of claim 1, further comprising a status notification component that notifies the warrantee of changes in status of the received warranty claim.

13. The system of claim 1, wherein the warrantor may revise the stored warranty information associated with the plurality of items.

14. A method of processing a warranty claim made by a warrantee for an item covered by a warranty provided by a warrantor, the method comprising:
allowing a warrantee to search a plurality of items, wherein the plurality of items are covered by warranties offered by one or more warrantors;
receiving from the warrantee a selection of an item from the plurality of items;
displaying warranty information for the selected item to the warrantee, wherein the warranty information is provided by the warrantor corresponding to the selected item;
receiving from the warrantee a warranty claim for the selected item, wherein the warranty claim includes an item identification and a warranty claim explanation; and
displaying to the warrantee information on how to tender the item to the warrantor in accordance with the received warranty claim.

15. The method of claim 14, wherein the item is a product.

16. The method of claim 14, wherein the item is a service.

17. The method of claim 14, further comprising storing the received warranty claim.

18. The method of claim 14, further comprising notifying the corresponding warrantor that the warranty. claim has been received.

19. The method of claim 18, further comprising enabling the corresponding warrantor to approve or reject the received warranty claim.

20. The method of claim 14, further comprising approving or rejecting the received warranty claim based upon stored rules provided by the corresponding warrantor.

21. The method of claim 14, further comprising displaying to the warrantee reports on warranty claims received from the warrantee.

22. The method of claim 14, further comprising displaying to the warrantor reports on warranty claims associated with the warrantor.

23. The method of claim 14, further comprising notifying the warrantee of changes in status of the received warranty claim.

24. The method of claim 14, further comprising permitting the warrantor to revise stored warranty information associated with the plurality of items.

25. A computer-readable medium whose contents cause a computing system to perform a method of processing a warranty claim made by a warrantee for an item covered by a warranty provided by a warrantor, the method comprising:
allowing a warrantee to search a plurality of items, wherein the plurality of items are covered by warranties offered by one or more warrantors;
receiving from the warrantee a selection of an item from the plurality of items;
displaying warranty information for the selected item to the warrantee, wherein the warranty information is provided by the warrantor corresponding to the selected item;
receiving from the warrantee a warranty claim for the selected item, wherein the warranty claim includes an item identification and a warranty claim explanation; and
displaying to the warrantee information on how to tender the item to the warrantor in accordance with the received warranty claim.

26. The computer-readable medium of claim 25, further comprising notifying the corresponding warrantor that the warranty claim has been received.

27. The computer-readable medium of claim 25, further comprising displaying to the warrantee reports on warranty claims received from the warrantee.

28. The computer-readable medium of claim 25, further comprising displaying to the warrantor reports on warranty claims associated with the warrantor.
